(19) United States
(12) Patent Application Publication
(10) Pub. No.: US 2016/0335531 A1
(43) Pub. Date: Nov. 17, 2016

(54) DYNAMIC SECURITY CODES, TOKENS, DISPLAYS, CARDS, DEVICES, MULTI-CARD DEVICES, SYSTEMS AND METHODS

(71) Applicant: Dynamics Inc., Cheswick, PA (US)

(72) Inventors: Jeffrey D. Mullen, Glenshaw, PA (US); Andrew Veter, Pittsburgh, PA (US); Jason Dyro, Lenexa, KS (US)

(21) Appl. No.: 15/153,380

(22) Filed: May 12, 2016

Related U.S. Application Data
(60) Provisional application No. 62/159,963, filed on May 12, 2015.

(51) Int. Cl. G06K 19/073; G06Q 20/34; G06K 7/08; G06K 19/077; G06K 19/06; G06K 19/07

(52) U.S. Cl. CPC G06K 19/07345; G06K 19/06112; G06K 19/06196; G06K 19/0702; G06K 7/087; G06K 19/07709; G06Q 20/3572

(57) ABSTRACT

A dynamic code of a transaction device may be validated by a remote processor by comparing the dynamic code to a verification code generated using a timestamp and identification data received from the transaction device. A static code may replace the dynamic code for authorization processing. A remote verification processor may synchronize to the transaction device using the timestamp. A token may be associated to each communication interface of a multi-card transaction device. A display may be directly connected to driver circuit on a display board of a transaction card. A radio IC chip may be included in a powered card. A multi-card device may toggle a plurality of display screens to display transaction data.

### CROSS-REFERENCE TO RELATED APPLICATION

This application claims the benefit of U.S. Provisional Patent Application No. 62/159,969, titled “DYNAMIC SECURITY CODES, TOKENS, DISPLAYS, CARDS, DEVICES, MULTI-CARD DEVICES, SYSTEMS AND METHODS,” filed May 12, 2015 (Attorney Docket No. D/152PROV), which is hereby incorporated by reference herein in its entirety.

### BACKGROUND OF THE INVENTION

Example embodiments relate to magnetic cards, devices and transaction systems.

### SUMMARY OF THE INVENTION

A method according to example embodiments may include receiving, by a server, data associated with a transaction card of a user, determining a multi-card transaction device associated with the user; determining a plurality of communication interfaces associated with the multi-card transaction device, associating a different token to each of the plurality of interfaces, associating the tokens to the transaction card, and communicating the tokens to the multi-card transaction device.

### BRIEF DESCRIPTION OF THE DRAWINGS

Principles and advantages of the present invention can be more clearly understood from the following detailed description considered in conjunction with the following drawings, in which the same reference numerals denote the same structural elements throughout, and in which:

FIG. 1 shows cards and architectures constructed in accordance with the principles of the present invention;

FIG. 2 shows devices constructed in accordance with the principles of the present invention;

FIG. 3 shows network topologies arranged in accordance with the principles of the present invention;

FIG. 4 shows transaction verification methods according to principles of the present invention;

FIG. 5 shows cards according to principles of the present invention;

FIG. 6 shows a card according to principles of the present invention;

FIG. 7 shows a token transaction method performed in accordance with the principles of the present invention; and

FIG. 8 shows a card according to principles of the present invention.

### DETAILED DESCRIPTION OF THE INVENTION

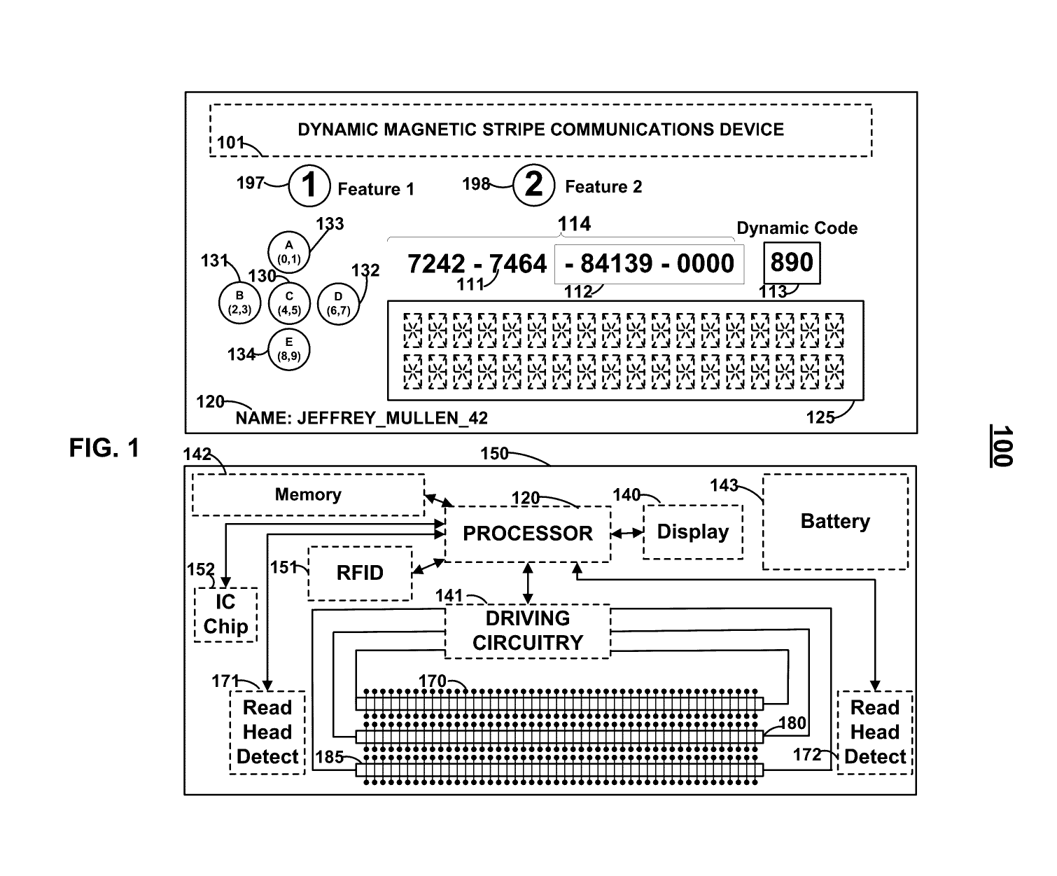

FIG. 1 shows cards and architectures according to example embodiments. Referring to FIG. 1, card 100 may be a dynamic powered card, and may include, for example, dynamic magnetic stripe communications device 101, one or more displays (e.g., displays 112, 113 and 125), permanent information 120, one or more buttons (e.g., buttons 130-134, 197 and 198) and/or dynamic number 114. Dynamic number 114 may include permanent portion 111. Permanent portion 111 may be, for example, printed, embossed and/or laser etched on card 100.

Multiple displays may be provided on card 100 for various purposes. For example, display 112 may utilized to entirely, and/or partially display a dynamic number. Display 113 may be utilized to display a dynamic code (e.g., a dynamic security code). Display 125 may display logos, barcodes and/or multiple lines of information. At least one of displays 112, 113 and 125 may be a bi-stable or non bi-stable display. A bi-stable display may be a display that maintains an image without power.

Permanent information 120 may include, for example, information specific to a user (e.g., a user's name and/or username) and/or information specific to a card (e.g., a card issue date and/or a card expiration date).

Buttons 131-134, 197 and 198 may be mechanical buttons, capacitive buttons, or a combination of mechanical and capacitive buttons. Buttons 131-134 may be used, for example, to enter information (e.g., an access code) and/or to make a selection. For example, using buttons 131-134, a user may select options displayed on display 125 that instruct card 100 to communicate (e.g., via a dynamic magnetic stripe communications device, RFID and/or exposed IC chip) a user's instructions to use a debit account, a credit account, a pre-paid account, and/or a point account for a transaction (e.g., a payment transaction). According to at least one example embodiment, more than one account may be selected. For example, a transaction may be divided between accounts and card 100 may be utilized to indicate a user's desire to use a point account until the point account is exhausted and then to use a credit account.

Button 197 may be used, for example, to communicate information through dynamic magnetic stripe communications device 101 indicative of a user's desire to communicate a single track of magnetic stripe information. Persons skilled in the art will appreciate that pressing a button (e.g., button 197) may cause information to be communicated through device 101 when an associated read-head detector detects the presence of a read-head of a magnetic stripe reader. Button 198 may be utilized to communicate (e.g., after button 198 is pressed and after a read-head detects a read-head of a reader) information indicative of a user selection (e.g., to communicate two or more tracks of magnetic stripe data, to communicate different track data, to modify tracks of data and/or the like).

Button 197 and button 198 may each be used to associate a feature to a transaction. For example, button 197 and button 198 may be associated to different service provider applications. Each service provider application may be associated to a different service provider feature (e.g., rewards). A user may, for example, press one or more of buttons 197 and 198 to choose one or more features for a particular transaction.

A user may associate applications to buttons and/or features to applications, for example, on a graphical user interface (GUI). The graphical user interface may be, for example, an application manager provided by one or more entities (e.g., an application manager provider). The associations may be changed, for example, at any time, periodically, and/or upon the occurrence of an event. According to some example embodiments, a user may associate applications to buttons and/or features to applications by telephone, by electronic mail and/or any other communication method.

Associations between buttons and service provider applications may be maintained by an ecosystem provider, for example, within an ecosystem of applications, transactional methods and types of transactions. When a transactional method (e.g., card 100) is used by a user, the ecosystem provider may receive transactional data and information indicative of a button selected by the user. The ecosystem provider may determine the identity of an application associated to the button, and may communicate some or all of the information and/or transactional data to the application and/or the service provider. The service provider and/or the application may provide a feature associated with the application based on the information and/or transactional data.

Display 125 may be an enhanced display, an improved display, and/or a large footprint display. For example, display 125 may be a 1 inch by 1 inch display, a 1 inch by 1.5 inch display, a 1 inch by 2 inch display, and/or the like. Display 125 may be centered, left justified, right justified, top justified, bottom justified and/or vertically justified. Display 125 may be, for example, a multi-segment, a multiline display, a dot matrix display and/or the like. A multiline display 125 may include two lines of 5-20 characters per line, for example, 9 characters per line, 10 characters per line and/or 18 characters per line. Card 100 may include a toggle button, a power button and/or a toggle power button (e.g., one of buttons 197, 198, 131, 132, 133 and 134, or a touch sensitive element of a touch sensitive display 125 and/or read head detectors 171 and 172, and/or the like).

Different features may be provided based on the use of different transactional methods and/or transaction types. For example, suppose a service provider provides a reward feature based on the use of a particular payment method (e.g., a reward for using a particular credit card). A user may purchase an item using the particular payment method (e.g., may select a particular credit account using buttons 130-134 and display 125). When the purchase is performed, the reward may be communicated to the user. As another example, suppose a service provider provides a reward feature based on a type of transaction. For example, a reward may be provided for a sale of a commodity using a particular transaction processor (e.g., issuer, acquirer and/or payment network). A user may sell a commodity using the particular transaction processor (e.g., the ecosystem provider) and upon completion of the sale a reward may be communicated to the user.

Selection of a feature may or may not have a cost associated with it. If a cost is associated with the feature, for example, the cost may be added to a customer's statement (e.g., added to a credit or debit purchase) for a particular transaction. A fixed-fee and/or variable-fee (e.g., a percentage of the transaction) may then be removed from the fee charged to the user and distributed among particular parties, for example, distributed among a card issuer, application manager provider, ecosystem provider, device provider, service provider and/or one or more other entities. Persons skilled in the art in possession of example embodiments will appreciate that many different fee arrangements are possible, and that the various providers may be the same and/or different from each other.

A cost may be associated to a feature selection, but may not be a cost to a user. For example, the cost may be a cost to a service provider (e.g., a third party service provider). The cost may be provided to other entities, for example, the device provider, card issuer, card processor, and/or any other entity (e.g., a card network).

Display 112 may display a dynamic number, for example, all or a portion of an account number (e.g., a credit and/or debit account number). Display 113 may display, for example, a dynamic verification code (e.g., a card verification value (CVV) and/or card identification number (CID)). The dynamic numbers displayed on displays 112 and 113 may change according to various schemes as a security measure against fraudulent transactions. For example, the dynamic numbers may change based on time and/or upon the occurrence of an event such that a previously recorded number may become unusable. The dynamic numbers may change with each transaction (e.g, each swipe of card 100), when card 100 is turned on, and the like.

Card 100 and/or a user may communicate a dynamic number to a processing facility. The processing facility may validate the dynamic number (e.g., a dynamic credit card number and/or a dynamic security code). A user may purchase items using a dynamic card and a processing facility may authorize the purchases upon determining that the dynamic number is valid.

Although example embodiments may be described with respect to numbers, the scope of example embodiments includes any distinguishing representation of a security code and/or account, by any sensory method (e.g., sight, sound, touch and/or the like). Characters, images, sounds, textures, letters and/or any other distinguishable representations are contemplated by example embodiments.

Generation of a dynamic number and the functionality needed to verify the dynamic number at a processing facility may be accomplished in a variety of ways. For example, a private key (or equation, hash table function and/or the like) and a secure card number (e.g., a private number) may be known to both the dynamic card (e.g., stored in memory 142 of a card 100) and the processing/authorization facility. A signal may be received or generated by the dynamic card (e.g., a counter signal, a randomly generated signal, a timing signal, etc.) and the dynamic card may produce a dynamic number based on the signal, the private key and/or the private card number. The processing facility may utilize the private key, private card number, the dynamic number, and/or the signal (or a different signal synchronized with the signal) to verify that the dynamic number is correct.

As one non-limiting example, a processing facility may receive a time stamp with a dynamic number and any other information received from a dynamic card (e.g., account identification information and expiration date). The processing facility may use the time stamp, the received dynamic card information (and any other received information), the private key, and the private number to verify that the dynamic number is correct for that period of time (or a string of consecutive periods of time that include, and are located near, the time stamp). A time stamp may be utilized, for example, to authorize online purchases and/or telephonic purchases that are not immediately processed. A time stamp may be indicative of, for example, a particular time or period of time.

According to at least one example embodiment, a timing may be independently determined by a dynamic card and a processing facility (e.g., using a same time source and/or synchronized timing sources) and a time stamp may not be communicated. According to other example embodiments, time may be synchronized between a card and a processing facility at the processing facility based on received timestamps.

Persons skilled in the art will appreciate that a dynamic card number may be produced without the need for a private number such as a private credit card number or security code, for example, a number stored in both a credit card and a remote facility. For example, a timing signal may be encoded based on the private key (or equation) and the resultant encoded number utilized as a dynamic credit card number. According to at least one example embodiment, a timing signal may be coded using a private credit card number.

A private key may be an equation or formula that uses one or more other variables (e.g., a random number) to generate a coded number (e.g., a dynamic number). Persons skilled in the art will appreciate that one or more private keys (e.g., an equation or formula) may be utilized to code different numbers for a dynamic card. For example, one private key may be utilized to code a dynamic card number while another private key may be utilized to code a dynamic security code (e.g., a verification code).

A number of private keys (and/or private numbers) may be stored in a credit card and such private keys (and/or private numbers) may be changed periodically (e.g., every day or week). A similar number of private keys (and/or private numbers) may be stored in a remote facility (e.g., a remote server), the selection of which may be determined by a particular time (e.g., a particular day or a particular week). A processing/authorization facility, or any device/facility, may receive the dynamic card number and decode the dynamic number based on a replica of the private key and/or private number of the card that is stored at, or accessible by, the facility (e.g., stored on a database and/or server).

Persons skilled in the art in possession of example embodiments will appreciate that synchronization between a card and a processing facility may not be required. For example, a counter on card 100 may increment each time card 100 is used. If information does not reach a processing facility a counter used by the processing facility may not also increment. The processing facility may authorize dynamic numbers that are valid within a range to avoid declining transactions that are otherwise valid (e.g., non-fraudulent). For example, if a dynamic number is recognized for another value of a counter within a range (e.g., within 10 increments of the counter from the value of the counter at the processing facility), the processing facility may authorize a transaction and set the counter at the processing facility to match the expected counter value at card 100. An algorithm and/or transaction history may be maintained to determine if non-synchronized validations exceed an expected error level. If the error level is exceeded, transactions may be declined.

For example, a card may, at the push of a button on a dynamic card, generate a new number (e.g., from a list of stored numbers). A remote facility may determine if the button was pressed on the dynamic card by determining if a future dynamic number is valid and, if a future number is valid, the remote facility may invalidate all numbers located before the newly validated number. At the next transaction, the dynamic facility may, for example, attempt to validate the received number with the number located after the newly validated number. A table may store, for example, a dynamic number and a pointer to the next entry. A processor may read a dynamic number and utilize the pointer to determine the location of the next dynamic number. Persons of ordinary skill in the art will appreciate that similar strategies may be used for schemes employing a timing signal and/or the like.

A remote processing/authorization facility may, for example, perform the same process as the dynamic card and compare the facility's dynamic number with the received dynamic number for verification. For example, a remote facility may include any equations and variables needed by the dynamic card to generate a dynamic number and may perform an operation similar to the one performed by the dynamic card to generate its own dynamic number. The remote facility may then compare the received dynamic number to the generated dynamic number to determine if the two numbers are the same and/or within an expected degree of similarity.

A remote processing/authorization facility may decode a dynamic number using an equation and/or a private key (which may be an equation itself or a variable) to obtain a resultant number and compare this number against a private number for approval. If the decoded number matches the private number (which may, or may not, be the same private number stored in the credit card), then the dynamic number may be validated.

A dynamic card may be utilized using traditional infrastructure and may be utilized for online (or telephonic) purchases and purchases that require the card to be swiped (or entered manually into a credit card reader). A dynamic number may be decoded at any point in a validation/authorization process. For example, an online store may include the components (e.g., hardware and/or software) necessary to decode the dynamic number such that a decoded number (e.g., a credit/debit card number) may be transmitted to a card processing facility.

A processing facility, or any device decoding a number, may utilize an identification number to identify the account/card that produced the dynamic number. The identification number may then be utilized to look up, for example, the private key and/or private number of the account/card such that a dynamic number can be generated from the retrieved information (and compared to the received dynamic number) and/or the retrieved information can be utilized to decode the dynamic number such that the card may be validated and/or a transaction authorized. Multiple users may utilize the same dynamic number at any one time and the identity of the account/card can still be determined (e.g., by using the identification information).

Identification information may be utilized to identify a credit card. Multiple users may be utilizing the same dynamic number (e.g., a dynamic credit card number or a dynamic verification code) at any time. The identification information may be utilized to identify a credit card such that a dynamic number can be, for example, retrieved/generated for a particular period of time (and/or a particular transaction) for the identified credit card and compared to the received dynamic number.

The dynamic card number may be transformed into a particular credit card format so that a dynamic number may be verified as having the appropriate format before, for example, the number is transmitted to a credit card processing/authorization facility. For example, a coding equation may be utilized that always produces numbers that fit a particular format.

A dynamic card system may allow multiple users to have the same dynamic number at any particular time. Additional information may be transmitted to identify the user. For example, an account number and/or name may be utilized. According to at least one example embodiment, a traditional credit card number may be written on a traditional magnetic stripe. Such a credit card number may be used for identifying the user. A dynamic security code (e.g., a four digit security code such as a verification code) may then be provided that changes periodically. Such dynamic information (e.g., the dynamic security code) may be written to a portion of the magnetic stripe that does not have the traditional credit card number and/or the dynamic information (e.g., the dynamic security code) may be displayed to a user.

A signal may be utilized to produce a key that is used in an equation to manipulate a credit card number. The signal may be a timing signal, a counter signal, a random number generator signal (e.g., that operates similar to a random number generator in a processing facility) and/or the like. Such a counter number (or random number) may be provided to a processing facility so that the processing facility may decode (or perform the same function as the dynamic card and compare the results). A credit card number may be invalidated at the facility if, for example, any particular number is used more than a particular number of times (e.g., more than 10 times). Such a counter may be increased after every purchase (e.g., after a user presses a button to change the number). As per another example, if a counter is used and the counter is increased when a number is used (or the credit card believes that a number has been used), the number of transactions operable of being made may be limited by the storage capacity of the counter.

According to example embodiments, a method of authorizing transactions using a dynamic number may not be subject to synchronicity. For example, according to at least one example embodiment, an issuer may associate a function composed of multiple variables to each transaction account (e.g., to each credit card account), and may issue card 100 to a user with the associated function and a random number generator (e.g., a computational or physical device). A random number generated by the random number generator may define each variable of the function. For each transaction, card 100 may generate a random number and determine a solution to the associated function using the random number to generate a dynamic number. Card 100 may communicate the random number, the dynamic number and an identifier, to a verification facility and/or device (hereinafter, “verifying entity”). The verifying entity may retrieve the function associated to card 100 from secure storage based on the identifier and/or may determine the function using the identifier. A solution to the retrieved/determined function may be calculated using the random number communicated by card 100 to generate a verification number. The verifying entity may determine whether or not the verification number matches the communicated dynamic number. A transaction may be authorized if, for example, a match is determined.

According to example embodiments, a function associated with an account need not be stored by card 100 and/or a verifying entity. For example, each account may be associated to a function determination value and a (same) base set of variables. The function determination value may identify operators and/or exponents of a function including the base variables. Each associated function may be completely determined for each transaction using the operators, exponents and base variables. If the function determination value is, as one non-limiting example, a 5 digit number in a decimal numeral system defining 3 different operators, a total of about 2700 different functions may be determinable.

According to example embodiments, an identifier communicated by card 100 to a processing facility may be a function determination value and/or may be information used by a processing facility to determine/retrieve the function determination value.

Architecture 150 may be utilized with any card (e.g., any card 100). Architecture 150 may include, for example, processor 120, display 140, driving circuitry 141, memory 142, battery 143, radio frequency identification (RFID) 151, integrated circuit (IC) chip 152, electromagnetic field generators 170, 180, and 185, and read-head detectors 171 and 172.

Processor 120 may be any type of processing device, for example, a central processing unit (CPU) and/or a digital signal processor (DSP). Processor 120 may be, for example, an application specific integrated circuit (ASIC). Processor 120 may include on-board memory for storing information (e.g., drive code). Any number of components may communicate to processor 120 and/or receive communications from processor 120. For example, one or more displays (e.g., display 140) may be coupled to processor 120. Persons skilled in the art will appreciate that components may be placed between particular components and processor 120. For example, a display driver circuit may be coupled between display 140 and processor 120.

Memory 142 may be coupled to processor 120. Memory 142 may store data, for example, data that is unique to a particular card. Memory 142 may store any type of data. For example, memory 142 may store, for example, a function, base variables and/or a function determination value used to generate a dynamic number. As another example, memory 142 may store discretionary data codes associated with buttons of card 100. Discretionary data codes may be recognized by remote servers to effect particular actions. For example, a discretionary data code may be stored in memory 142 and may be used to cause a third party service feature to be performed by a remote server (e.g., a remote server coupled to a third party service such as an online voucher and/or coupon provider).

Different third party features may be, for example, associated with different buttons and a particular feature may be selected by pressing an associated button. According to some example embodiments, a user may select a third party feature from a list displayed to the user. For example, the user may scroll through a list of features on a display (e.g., a display on the front of the card). A user may scroll through a list using buttons on card 100. The list of features may be displayed to the user individually (e.g., one or more buttons may be used to change which feature is displayed), in groups and/or all features may be simultaneously displayed.

According to at least one example embodiment, a user may select a type of payment on card 100 via manual input interfaces. The manual input interfaces may correspond to displayed options (e.g., displayed on display 125) and/or may be independent buttons. Selected information may be communicated to a magnetic stripe reader via a dynamic magnetic stripe communications device. Selected information may also be communicated to a device (e.g., a mobile telephonic device) including a capacitive sensor and/or other type of touch sensitive sensor.

Architecture 150 may include any number of reader communication devices. For example, architecture 150 may include at least one of IC chip 152, RFID 151 and a magnetic stripe communications device. IC chip 152 may be used to communicate information to an IC chip reader (not illustrated). IC chip 152 may be, for example, an EMV chip. RFID 151 may be used to communicate information to an RFID reader. RFID 151 may be, for example, a RFID tag. A magnetic stripe communications device may be included to communicate information to a magnetic stripe reader. For example, a magnetic stripe communications device may provide electromagnetic signals to a magnetic stripe reader.

Different electromagnetic signals may be communicated to a magnetic stripe reader to provide different tracks of data. For example, architecture 150 may include electromagnetic field generators 170, 180 and 185 to communicate separate tracks of information to a magnetic stripe reader. Electromagnetic field generators 170, 180, and 185 may include a coil (e.g., each may include a coil) wrapped around one or more materials (e.g., a soft-magnetic material and a non-magnetic material). Each electromagnetic field generator may communicate information, for example, serially and/or in parallel to a receiver of a magnetic stripe reader for particular magnetic stripe track.

Architecture 150 may include read head detectors 171 and 172. Read-head detectors 171 and 172 may be configured to sense the presence of a magnetic stripe reader (e.g., a read-head housing of a magnetic stripe reader). Information sensed by the read-head detectors 171 and 172 may be communicated to processor 120 to cause processor 120 to communicate information serially from electromagnetic generators 170, 180, and 185 to magnetic stripe track receivers in a read-head housing of a magnetic stripe reader.

According to at least one example embodiment, a magnetic stripe communications device may change the information communicated to a magnetic stripe reader at any time. Processor 120 may, for example, communicate user-specific and card-specific information through RFID 151, IC chip 152, and/or electromagnetic generators 170, 180, and 185 to card readers coupled to remote information processing servers (e.g., purchase authorization servers). Driving circuitry 141 may be utilized by processor 120, for example, to control electromagnetic generators 170, 180 and 185.

Architecture 150 may include, for example, a light sensor (not illustrated). Architecture 150 may receive information from a light sensor. Processor 120 may determine information received by a light sensor.

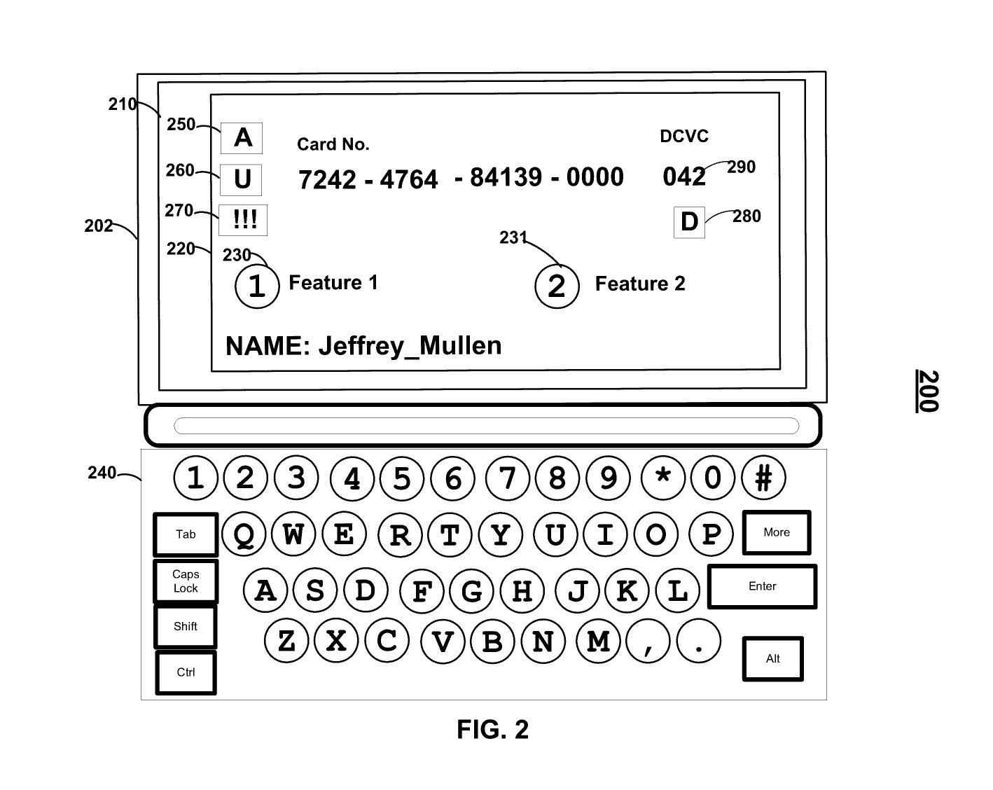

FIG. 2 shows devices according to example embodiments. Referring to FIG. 2, device 200 may be, for example, a mobile telephonic device and/or other device (e.g., portable computer such as a portable tablet computer). Device 200 may include, for example, housing 202, display 210, device card 220, virtual buttons 230-232, virtual keyboard 240, selections 250-290, and/or dynamic code 290.

Display 210 may include, for example, light-sensitive and/or touch-sensitive elements. Device 200 may communicate information to a card reader, for example, via a contactless signal (e.g., an RFID signal) and/or a contact-based signal (e.g., a USB connection). Any of multiple different communication technologies may be used to communicate information to, for example, a card reader.

Device 200 may include a device card 220 and/or virtual buttons 230 and 231. Device card 220 may be a virtual representation of a card and/or any information identifying a payment method (e.g., credit account number). Persons skilled in the art will appreciate that any physical card described herein may be provided as a device card on, for example, a computing system (e.g., a mobile telephonic device and/or a computer). Physical buttons of a physical card may, for example, correspond to virtual buttons of a device card.

Virtual button 230 may, for example, correspond to one feature (e.g., an automatic association of a coupon to a purchase) from one service provider. Virtual button 231 may, for example, correspond to another feature (e.g., a virtual game reward) from the same or a different service provider.

All features associated to a card may be utilized, for example, with a particular payment account (e.g., a credit account) such that a payment transaction with that payment account is performed if any feature is selected. As another example, one or more features may be associated with a payment account (e.g., a credit account) while an additional one or more features may be associated with a different payment account (e.g., a debit account). Accordingly, a selected feature associated with a credit account may be utilized to make a purchase with credit and may perform an additional action associated with that feature. A different selected feature associated with a debit account may be utilized to make a purchase with debit and may perform an additional action associated with that different feature.

Selection 250 may be, for example, a link to an application for a new card provided by, for example, an ecosystem provider, application manager provider, card manufacturer and/or the like. Upon activation of selection 250 a user may be directed to an application form. Selection 260 may be, for example, a link to an application for an upgrade to a new card provided by, for example, an ecosystem provider, application manager provider, card manufacturer and/or the like. Upon activation of selection 260 a user may be directed to an application form. According to at least one example embodiment, selections 250 and 260 may only appear upon availability to a user and may not require an application process (e.g., may be based on preapproval).

Selection 270 may be, for example, a link used to report a lost and/or stolen device, device card and/or physical card. Upon activation of selection 270 information may be automatically communicated to one or more responsible parties, for example, an issuer (e.g., for deactivation of the payment method). Selection 280 may be, for example, a link used to display a GUI. Upon activation of selection 280 an application manager used to associate features to virtual buttons, and virtual buttons to payment methods, may be displayed.

Dynamic code 290 may be, for example, a credit card number, a CVV and/or a CID. Dynamic code 290 may change based on an event, for example, based on a change in time, a counter and/or the like. Dynamic code 290 may change based on a transaction using, for example, a function and/or formula. For example, dynamic code 290 may change every transaction, every number of transactions, for a type of transaction (e.g., greater than $100 and/or using a debit card) and/or the like.

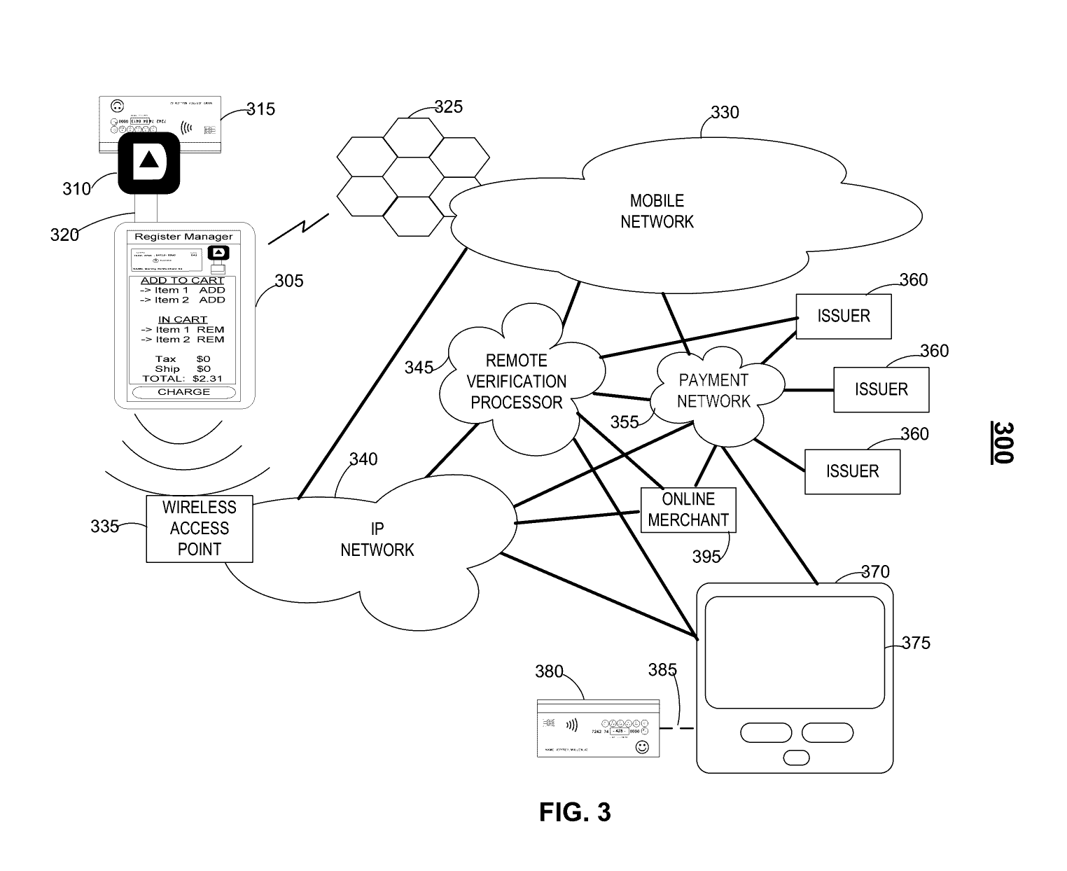

FIG. 3 shows network topologies according to example embodiments. Referring to FIG. 3, network topology 300 may be a logical topology of a transactional network including multiple network elements (e.g., servers, routers, switches, user devices, communications infrastructure and/or the like). The network elements may include, for example, mobile device 305, card reader 310, card 315, network access infrastructure 325, mobile network 330, wireless access point 335, IP network 340, remote verification processor 345, payment network 355, issuers 360, device 370, contactless device 380 and/or online merchant 395.

Card 315 may be, for example, a powered and/or dynamic card. Mobile device 305 may be, for example, a mobile telephonic device, a personal digital assistant (PDA), an electronic tablet, a laptop, a global positioning system (GPS), an MP3 player, a smartphone and/or the like. Mobile device 305 may be used by any transactional entity, for example, a user, a merchant, a biller, an enterprise, a government, a non-profit organization and/or the like. Card reader 310 may be, for example, a data input device configured to receive data from a data device (e.g., card 315). For example, card reader 310 may receive data from a magnetic stripe, EMV chip, contactless (e.g., RFID) technology and/or the like. Card reader 310 may connect to mobile device 305 via, for example, interface 320. Interface 320 may be an input to, for example, any one of multiple ports of a mobile device 305, for example, an input to a universal serial bus (USB) port, MicroUSB port, 32-pin connector, a headphone jack, an Ethernet port and/or the like.

Remote verification processor 345 may be a network element of an entity performing data verification, for example, a remote service provider. Remote verification processor 345 may be a remote processing facility including one or more computing devices (e.g., servers) verifying dynamic data communicated during a transaction. Dynamic data may be, for example, data associated with, and/or communicated in lieu of, a static security code, such as a card verification code or card verification value code (e.g., CVV, CVV2, CVC, CVC2, CID and/or the like). The dynamic data may be conventionally placed within a transaction message, and/or may be placed in a discretionary field of a transaction message (and/or other fields).

A dynamic code verified by remote verification processor 345 may be dynamic data associated with and/or representative of any transactional data, such as an expiration date, payment data, third party data, a card number, portions of a card number, information printed on a transaction device, information displayed by a display of a transaction device, data associated with printing on a transaction device (e.g., a number of times a particular symbol is printed on a transaction device) and/or the like. Third party data may be, for example, merchant data associated with a purchase and/or associated with a merchant (e.g., a merchant ID) that may be used to verify that a valid merchant communicated transactional information.

Issuers 360 may be issuer processors and/or issuers of transactional methods compatible with dynamic security code transactions (e.g., issuing financial institutions). Payment network 355 may be, for example, one or more network elements routing transactional information between, for example, remote verification processor 345 and issuers 360.

Remote verification processor 345, issuers 360, and/or payment network 355 may be connected by, for example, IP network 340, mobile network 330, private networks, trusted networks, encryption networks, sub-networks and/or the like. Connections between network elements may be wired and/or wireless.

Mobile device 305 may include one or more transceivers, receivers and/or transmitters that may communicate with one or more wired networks (e.g., IP network 340 and/or payment network 355) and/or one or more wireless networks (e.g., mobile network 330). Mobile device 305 may, for example, communicate with a cellular station over a wireless radio interface (e.g., a global system for mobile communications (GSM) air interface and/or the like) that may be used by mobile device 305 to communicate information (e.g., voice and data) to cellular network access infrastructure 325 (e.g., one or more GSM base transceiver stations, base station controllers and mobile switching centers). Persons skilled in the art will appreciate that cellular network access infrastructure 325 may utilize any multiple access architecture, for example, a code-division multiple access architecture and/or a time-division multiple access architecture.

Mobile device 305 may communicate with wireless access point 335 over a wireless interface (e.g., a Bluetooth interface, Wi-Fi interface and/or the like). Mobile device 305 may, for example, access one or more wired networks (e.g., IP network 312 and/or payment network 314) and/or one or more wireless networks (e.g., mobile network 310) without the need to first gain access to cellular network access infrastructure 325.

Mobile device 305 may initiate a financial transaction with one or more network entities and/or devices. Transactional information may be used to process the financial transaction and may include, for example, identification data, a dynamic number, and/or a time stamp. Transactional information may be used to verify that a dynamic number is correct. According to at least one example embodiment, the transactional information may include magnetic stripe data.

The transactional information may be communicated to mobile device 305 from card 315 via card reader 310. According to at least one example embodiment, a portion of the transactional information may be communicated to mobile device 305 from card 315, and a different portion may be provided by mobile device 305. For example, dynamic data, a timestamp and identification data may be provided by mobile device 305.

The financial transaction may include, for example, a purchase of items for sale by a user. A purchaser's request to purchase the items may be initiated by a browser and/or application of mobile device 305 via an access point, for example, wireless access point 335 and/or cellular network access infrastructure 325. Mobile device 305 may obtain payment information including an identification code, dynamic data and/or a time stamp via card reader 310 (e.g., when card 315 is swiped through card reader 310), and may communicate the payment information to one or more network elements for transactional processing. The time stamp may be, for example, based on clock signal generated internally and/or externally to card 315.

According to some example embodiments, card 315 may include a receiver and/or transceiver, and may synchronize and/or resynchronize to remote verification processor 345, and/or remote verification processor 345 may synchronize to card 315, for example, using the timestamp. Using processor-side-synchronization, component differences between cards (e.g., part variability, wear and/or bending), different ambient conditions in which a card is used, bending of cards by users, differences induced during manufacture of cards, network delays, transaction delays and other variability may be accounted for by remote verification processor 345.

As another example, the financial transaction may include a purchase of items for sale by online merchant 395. The purchaser's request to purchase the items from online merchant 395 may be initiated by a browser of mobile device 305 via an access point, for example, wireless access point 335 and/or cellular network access infrastructure 325. Mobile device 305 may obtain payment information including an identification number, a dynamic data and/or a time stamp via card reader 310, for example, when card 315 is swiped through card reader 310. The payment information may be used to populate entry fields on a webpage of online merchant 395, including a dynamic data entry field and/or a time stamp field. In addition to, or alternatively, all or a portion of the payment information may be displayed on, for example, a display of card 315 and/or a display of mobile device 305, and manually entered using mobile device 305.

The same dynamic data as communicated by card 315 via a communication interface (a dynamic magnetic stripe, an IC chip, an RFID, a Bluetooth interface, and/or the like) may be displayed. Different dynamic data from the dynamic data communicated by card 315 may be displayed. For example, the dynamic data communicated via a communication interface may be based on a separate algorithm than the dynamic data displayed by card 315. The display may be toggled so that all dynamic data may be cycled through. According to some example embodiments, card 315 may include multiple displays, and at multiple interfaces. Each display and interface may provide a different dynamic code based on a different algorithm, and/or one of the displays may display the dynamic code communicated by an interface.

According to at least one example embodiment, a portion of the payment information may be displayed by card 315, a portion of the payment information may be printed on card 315, and the portions of the payment information may be entered using mobile device 305. Online merchant 395 may receive and then communicate the payment information. For example, the payment information may be communicated by online merchant 395 to one or more network elements for transactional processing.

Transactional processing may include multiple transactional events and associated transactional communication flows. Examples of transactional events may include authorizations, dynamic data verifications, settlements, statement debits (e.g., piggyback events), statement credits, returns, partial returns, voids, adjustments and/or chargebacks. Examples of transactional communication flows may include authorization, batching, clearing and funding.

According to example embodiments, dynamic data that is part of transactional information may be verified by remote verification processor 345. For example, dynamic data verification may be included as part of authorization, batching, clearing and/or funding. According to other example embodiments, dynamic data verification may be a separate transactional communication flow, for example, independent of authorization, batching, clearing and funding.

Mobile device 305 may communicate transactional information including dynamic data during a transaction, for example, a purchase transaction. For example, dynamic data, a timestamp and an identification number may be communicated to remote verification processor 345 by a transactional entity. The communicating transactional entity may be, for example, mobile device 305, payment network 355, online merchant 395, one or more of issuers 360, an issuer processor (not shown), a merchant acquirer and/or the like. Remote verification processor 345 may determine whether the dynamic data is valid and communicate the determination to a receiving transactional entity. The receiving transactional entity may be, for example, mobile device 305, payment network 355, online merchant 395, one or more of issuers 360, an issuer processor (not shown), a merchant acquirer and/or the like.

According to example embodiments, dynamic data verification may be performed prior to, during or after transaction processing, or a stage of processing. For example, prior to, during or after authorization processing. The receiving transactional entity may be the same or different from the communicating transactional entity. The communicating transactional entity and the receiving transactional entity may be based on the stage and/or communication flow of a transaction. According to some example embodiments, dynamic data verification may be independent of a communication flow. For example, a merchant may verify dynamic data via remote verification processor 345 prior to initiating a communication flow.

According to example embodiments, all of the transactional information or a portion of the transactional information may be communicated to remote verification processor 345. According to at least one example embodiment, more than one transactional entity may communicate transactional information to remote verification processor 345. According to at least one example embodiment, more than one transactional entity may be a receiving transactional entity and remote verification processor 345 may communicate the determination of whether the dynamic data is valid to multiple entities (e.g., mobile device 305 and an authorizing entity).

Remote verification processor 345 may determine, for example, a private key used by card 315 to generate dynamic data, as well as inputs to the private key not received from network 355 (if any), by comparing the identification number against stored information. For example, the identification number may be compared to information stored in a database associating identification numbers to private keys. The identification number may be unique and the stored information may include a private key uniquely associated with card 315. The identification number may be either unique or non-unique, and the stored information may include a private key associated with multiple cards, including card 315.

Remote verification processor 345 may generate comparison data using, for example, the determined private key, the timestamp, and any other inputs to the determined private key. Remote verification processor 345 may generate comparison data using, for example, the determined private key, a time at which remote verification processor 345 receives the timestamp, and any other inputs to the private key. The comparison data may be compared to the dynamic data to determine whether the dynamic data is valid. For example, if the comparison data and the dynamic data are identical, or within a range of dynamic data based on the timestamp, the dynamic data may be determined to be valid.

According to some example embodiments, dynamic data verification may be based on prior verifications. For example, comparison data may be based on data stored at remote verification processor 345 with respect to previous verifications of card 315, a different card, or multiple different cards.

If the dynamic data is determined to be valid, remote verification processor 345 may notify a receiving entity that the dynamic data is valid. For example, remote verification processor 345 may insert static data associated with the dynamic data into the transactional information (e.g., replace the dynamic data with the static data) such that the modified transactional information may be authorized by a conventional authorizing entity, and communicate the modified transactional data to the receiving entity (e.g., an authorization server). As another example, remote verification processor 345 may insert alert data indicative of valid dynamic data into the transactional information and communicate the modified transactional information to a network device of the receiving entity. As another example, remote verification processor 345 may forward or return transactional information to the network device of the receiving entity for authorization processing, including the dynamic data without the static data (e.g., where the dynamic data matches the static data). As yet another example, remote verification processor 345 may communicate a different message to the network device of the receiving entity indicating that valid dynamic data was received.

Persons of ordinary skill will appreciate that a different transactional data string may be used instead of a modified transactional data string. As one example, a different transactional data string may be used where remote verification processor 345 communicates transactional information received from a network entity in one data format to a network entity using a different data format. For example, transactional information received from a merchant may be in a different format than used by payment network 355. As another example, transactional information received from payment network 355 may be in a different format than used by one or more of issuers 360.

According to example embodiments, multiple different entities may be receiving entities and remote verification processor 345 may communicate verification data differently to each receiving entity based on a format each entity typically receives or is capable of receiving.

If the dynamic data is determined to be invalid, remote verification processor 345 may notify a receiving entity that the dynamic data is invalid. For example, remote verification processor 345 may insert alert data indicative of invalid dynamic data (e.g., a static code that is not a solution to an equation or include in a LUT) into the transactional information and communicate the modified transactional information to a network device of the receiving entity. As another example, remote verification processor 345 may forward transactional information to a network device of a receiving entity for authorization processing, including the dynamic data without the static data (e.g., in a case where the dynamic data does not match the static data). As yet another example, remote verification processor 345 may communicate a different message to a receiving entity indicating that invalid dynamic data was received. The different message may be, for example, communicated to the entity from which the transactional data was received such that authorization is not performed.

According to some example embodiments, static data need not be used. For example, both an authorizing entity and remote verification processor 345 may expect dynamic data based on different equations. If the received dynamic data is valid, remote verification processor 345 may, for example, determine the dynamic data expected by the authorizing entity, and insert the expected data. If the received dynamic data is invalid, remote verification processor 345 may determine the dynamic data expected by the authorizing entity, and communicate data other than the data expected by the authorizing entity.

Remote verification processor 345 may store synchronization data used to adjust comparison data. Synchronization data may include, for example, an offset to a time determined at remote verification processor 345. The offset may compensate for timing signal differences between card 315 and remote verification processor 345.

The time determined at remote verification processor 345 may be modified by the offset and adjusted comparison data may be generated. The adjusted comparison data may be compared to the dynamic data. The offset may be used to adjust the time determined at remote verification processor 345, a received timestamp and/or a value based on the time determined at remote verification processor 345 and the received timestamp (e.g., modify a difference).

The offset may initially be, for example, a difference between a timing signal used by card 315 and a timing signal used by remote verification processor 345 at the time card 315 is manufactured. Card 315 may include a clock to generate a timing signal and/or may include an antenna and/or surface contacts to receive a timing signal from an external device. According to some example embodiments, the offset may initially be a difference between a timestamp received by remote verification processor 345 from card 315 and a time when the timestamp is received, either at the time of manufacture or otherwise. The timestamp and the time at remote verification processor 345 may each be based on any timing source, for example, a clock or a time service (e.g., NIST web clock).

The offset may be recalculated (modified or replaced), for example, at each transaction, after a period of time, at a time based on a drift rate of one or more clocks and/or at an arbitrary time. The offset may be recalculated based on a difference between a timestamp received from card 315 during a transaction and a time the transactional information is received by remote verification processor 345 (e.g., upon determining that the dynamic data is valid).

The offset, the time stamp, the time when the timestamp is received, and/or data based on the timestamp and the time when the timestamp is received, may be modified by network delays. A network delay may be an arbitrary value, a value reported by a network, and/or a measured value. The network delay may be a measured value received with the transactional information and/or a value determined by remote verification processor 345. For example, upon receiving the timestamp, remote verification processor 345 may measure network delay associated with transaction information by pinging mobile device 315 through the network element from which the timestamp was received. The delay may be determined based on the time between communicating the ping request and receiving a response from device 315. Absent network asymmetry, the delay may be divided in half and applied to the offset. However, if data traffic in one direction is slower than a different direction, routed along a different path, and/or any other asymmetry, the network delay may be determined based on the asymmetry. Any network characteristic may be used to determine network delay, for example, queue congestion, quality of service assignments, jitter differences, the time of day, the date, and/or the like.

According to some example embodiments, the offset may be replaced without recourse to prior data. According to other example embodiments, historical data may be used to determine a current offset. For example, an offset error algorithm using past data and new data may be used to determine a new offset. Past offsets may be used to calculate the new offset in order to reduce error due to potential variability in any factor causing a delay between a time at which card 315 generates a timestamp and a time the remote verification processor 345 determines a time, for example, an unmeasured delay or an erroneously measured delay.

According to some example embodiments, network delay may be applied to a difference between a current timestamp and the determined time, and the result used as an input to the offset error algorithm. According to other example embodiments, time difference data and network delay data may be stored, and one or both may be manipulated before being applied to the offset error algorithm as an input (e.g., in simple form, the offset error algorithm may receive averaged data as inputs).

According to some example embodiments, measurements of network characteristics and time differences may be stored by remote verification processor 345, and newly received times and measurements may by compared to the stored information to determine if differences between new data and historical data exceed respective minimum or maximum thresholds. If each individual difference does not exceed an associated minimum threshold or does exceed an associated maximum threshold, the data may be disregarded and the offset may remain the same, absent a data trend detected by remote verification processor 345. For example, a minimum threshold may indicate a negligible difference and a maximum threshold may indicate an outlier. According to some example embodiments, particular differences may be disregarded in determining the offset based on one or more thresholds such that only a portion of new data is used to recalculate the offset. Similarly, the differences may be combined and the combined differences may be compared to a single minimum and single maximum threshold to determine if offset recalculation will occur. Accordingly, computation resources may be conserved.

Merchant information may be used to at least temporarily (e.g., for a particular transaction) modify the offset or used as a separate offset. Merchant information may be communicated to remote verification processor 345, for example, with the information communicated by payment network 355. The merchant data may be used to determine merchant delay data associated with a particular merchant or a type of merchant using, for example, a database.

For example, if the determined difference between the timestamp and the time at remote verification processor 345 exceeds a threshold or results in an invalid comparison, remote verification processor 345 may determine the type of merchant from the merchant data. If the type of merchant is, for example, a merchant that delays transaction processing (e.g., batches transactions) or communication of the timestamp is otherwise delayed as a function of the type of merchant (e.g., manual entry related to online merchant 395), an additional offset may be applied or dynamic data verification may be waived.

Accordingly, for example, remote verification processor 345 may determine the time determined when the timestamp is received, modify the time with one or more offsets, and generate comparison data. The comparison data may be compared to the dynamic data to determine if the dynamic data is valid.

Persons of ordinary skill will appreciate that dynamic data verifications and/or time based evaluations by a remote verification processor permit dynamic data verification without requiring changes to existing infrastructure of financial institutions, including merchants, payment network 355, issuers 360, payment processors (not shown), merchant acquirers (not shown) and any other entity within the communication path of transaction data. Persons of ordinary skill will appreciate that synchronization by remote processor 345, without synchronization by card 315, includes multiple benefits. For example, power consumption at card 315 may be reduced. Further, network delays and merchant characteristics may be considered.

According to some example embodiments, remote verification processor 345 may perform timestamp verification. Timestamp verification may be performed by, for example, determining a difference between the timestamp received from card 315 and the time determined at remote verification processor 345, and comparing the difference to a threshold. If the time difference is invalid based on the threshold, the dynamic data may be determined invalid without generating the comparison data. Accordingly, a timestamp verification may be performed prior to verifying dynamic data and a message indicating that the dynamic data is invalid may be communicated to payment network 355 regardless of whether the dynamic data would otherwise be determined as valid. According to other example embodiments, both dynamic data verification and timestamp verification may be performed, and results of both verifications may be communicated to payment network 355.

As one non-limiting example, a network element within payment network 355 may receive transactional information from card 315 via mobile device 305 and any access infrastructure. The transactional information may include an identification number identifying card 315, a timestamp and dynamic data generated by a processor of card 315 using a private key and the timestamp. The dynamic data may be, for example, a dynamic CVC (“DCVC”). Payment network 315 may inspect the transactional information and determine that the transactional information includes the DCVC. The transactional information may be forwarded, or a portion of the transactional information may be communicated, to a remote facility, as a result of determining a DCVC is present.

The remote facility may be, for example, remote verification processor 345. Remote verification processor 345 may not be affiliated with conventional transaction processing entities and/or communication flows. For example, remote verification processor 345 may be a dynamic and/or powered card manufacturer producing feature cards, PIN cards, wallet cards and/or multi-brand cards. Remote verification processor 345 may perform other functions, may not be a card manufacturer and only verify dynamic codes, or may not be a card manufacturer and perform other functions besides dynamic code verification.

Remote verification processor 345 may determine a private key associated to card 315, as well as inputs to the private key not received from network 355 (if any), by comparing the identification number against stored information. For example, the identification number may be compared to information stored in a database associating identification numbers to private keys. The identification number may be unique and the stored information may include a private key uniquely associated with card 315. The identification number may be either unique or non-unique, and the stored information may include a private key associated with multiple cards, including card 315.

Remote verification processor 345 may generate comparison data using, for example, the determined private key, a time at which remote verification processor 345 receives the timestamp, and any other inputs to the a private key. The comparison data may be compared to the DCVC to determine whether the DCVC is valid. For example, if the comparison data and the DCVC are identical, or within an allowed range of DCVCs, the DCVC may be determined to be valid. The DCVC may be replaced with a CVC associated with the DCVC, and communicated to payment network 355 for authorization processing. If the DCVC is determined to be invalid, the transactional information (modified or unmodified to indicate invalidity) may be communicated to payment network 355 and/or a different type of message may be communicated.

According to some example embodiments, only the static CVC may be communicated to payment network 355 and/or the static CVC may be included in a general message. The message may be in the same or different format from the message received by remote verification processor 345 from payment network 355. According to some example embodiments, as part of an ISO response, a formatted ISO message (e.g., a 110) may be communicated and the CVC placed in a field for security related information (field 53) or a field reserved for other uses (e.g., field 55 and/or field 56).

According to some example embodiments, remote verification processor 345 may receive a portion of transactional information and may communicate a message including the CVC to payment network 355. Payment network 355 may replace the DCVC in the original transactional information with the CVC received in the validation message, and communicate the transactional information to one or more of issuers 360 for full approval of the transaction. The issuer(s) may communicate a message approving or declining the transaction, or a portion of the transaction associated with the particular issuer, to payment network 355 for routing to mobile device 305.

If the DCVC is determined to be invalid, the transactional information (modified or unmodified to indicate invalidity) may be communicated to payment network 355 and/or a different type of message may be communicated.

According to some example embodiments, a full ISO authorization request, a JSON version, and/or an XML version may be communicated to remote verification processor 345 (0100 message types). Remote verification processor 345 may receive messages in ISO format, ASCII format, JSON format, XML format and/or another transaction format.

The transactional message may be communicated to remote verification processor 345 via, for example, web services (e.g., Rest based and/or SOAP based, with or without SAML) and/or direct socket point-to-point communication using an MPLS between data centers of remote verification processor 345 and data centers of payment network 355. A redundant MPLS line may be established to improve availability. Either a push or pull process may be used (e.g., transactional information may be pushed to remote verification processor 345).

According to some example embodiments, remote verification processor 345 may operate under the same guidelines as standard ISO message processing. Remote verification processor 345 may support all message types, including Network messages such as LogOn, LogOff and Heartbeats. The message may be encrypted using, for example, EBCDIC or ASCII encoding, and may utilize BitMap ISO functionality to determine which fields are being provided at a given time. Fields may be fixed or variable length, and may be BCD formatted as needed.

Remote verification processor 345 may respond to any message received with an ISO formatted message, including data from the original message. The ISO message may be formatted as a response message (e.g., a 110 in response to a 100). The fields included in the ISO message may be based on fields identified by payment network 355 to perform the appropriate processing. Remote verification processor 345 may perform a LogOn (message type 800) to initiate the flow of data to remote verification processor 345. Communication may flow in an asynchronous manner, even over a single connection. Information within the response may be utilized by payment network 355 to match the original authorization message to perform processing.

Upon authorization of a purchase, payment information may be recorded onto a receipt that may be delivered to mobile device 305 via any one or more delivery options (e.g., via a short messaging service of mobile network 330 and/or an email delivery service of IP network 340). A payment receipt may, for example, be provided to mobile device 305 as a proof-of-purchase object (e.g., a barcode) that may be provided to a display of mobile device 305 and read by other computing equipment (e.g., a barcode scanner) for proof-of-purchase confirmation.

Authorized transactions may be batched (e.g., aggregated) by mobile device 305 and/or by a merchant acquirer associated with mobile device 305. The batched transaction may be cleared by communicating (e.g., daily) the batched transactions to one or more of issuers 360 (routed by, for example, payment network 314), debiting the purchaser's account and communicating a monetary value from one or more of issuers 360 to mobile device 305 and/or to a merchant acquirer associated with mobile device 305. Funding may include mobile device 305 and/or a merchant acquirer associated with mobile device 305 notifying a user associated with mobile device 305 that funding has occurred and/or communicating the monetary value to mobile device 305 (and/or a financial institution associated with mobile device 305). Conventional communication flows may be used. Various fees may be deducted from the monetary value and paid to various entities during transactional processing.

Device 370 may be, for example, a server, a laptop computer, a PDA, a desktop computer, a mobile device, a stand-alone piece of electronic equipment, and/or the like. Contactless device 380 may be, for example, a powered card and/or a non-powered card (e.g., a powered payment card and/or a non-powered payment card). Device card 375 may be a virtual representation of contactless device 380 or may be an independent device card. Device 370 may include a contactless interface that may initiate, sustain, and/or terminate communication channel 385 between contactless device 380 and device 370. Contactless device 380 and device 370 may communicate via channel 385 using any number of contactless mediums, which may include for example, visible, audible, capacitive, electromagnetic, magnetic, and/or RF mediums.

Contactless device 380 may communicate at least a portion of transactional information to device 370 to initiate a financial transaction (e.g., a purchase) using, for example, an IC chip, RFID tag a magnetic stripe, and/or a dynamic magnetic stripe communications device. Information may be communicated from contactless device 380 to device 370 in support of, for example, processing of the financial transaction. For example, device 370 may communicate transactional information, merchant data and/or transaction specific data to remote verification processor 345. Remote verification processor 345 may verify that a dynamic code (e.g., a CVV and/or CID) included in transactional information is valid. Remote verification processor 345 may verify the dynamic code, replace the dynamic code with a static code, and communicate the modified transactional data to one or more of issuers 360 for authorization of the transaction. One or more of issuers 360 may communicate the authorization to device 370. The user may be provided a receipt upon authorization of the financial transaction.

Device 370 may batch the authorized transaction with other transactions and communicate the batched transactions to one or more of issuers 360, and/or a merchant acquirer of device 370 may batch the transactions. Device 370 and/or a merchant acquirer of device 370 may request payment from one or more of issuers 360. The one or more issuers 360 may communicate a monetary value to device 370 and/or a merchant acquirer of device 370, and debit the user's account. The one or more issuers 360 may communicate the monetary value to device 370 and/or notify device 370 that funding has occurred. Conventional communication flows may be used. Various fees may be deducted from the monetary value and paid to various entities during transactional processing.

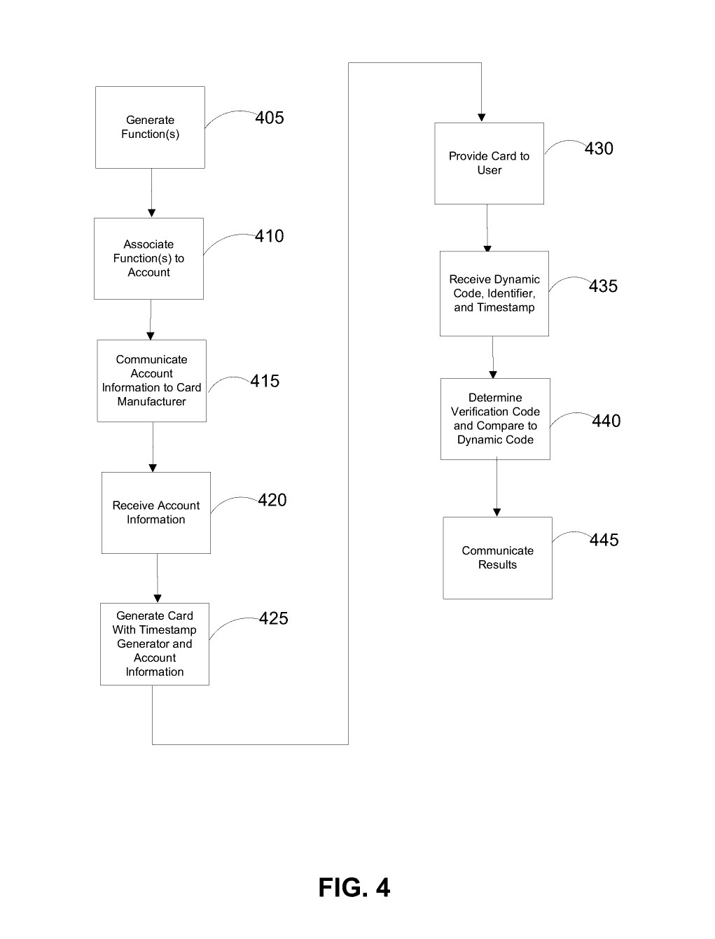

FIG. 4 shows transaction verification methods according to principles of the present invention. Referring to FIG. 4, an account provider (e.g., a credit issuer) may generate one or more functions for dynamic code generation (e.g., as in 405). The account provider may associate the function(s) to one or more accounts (e.g., as in 410) and communicate account information including the function(s), or data associated with the function(s) to a card manufacturer (e.g., as in 415). The card manufacturer may be a separate entity from the account provider and/or the same entity. Persons skilled in the art will appreciate that no communication may occur in a case where the account provider and card manufacturer are a same entity.

The card manufacturer may receive the account information and generate a card (e.g., as in 420 and 425). The card may be, for example, a powered card and/or a device card. The card and/or device may include a clock and the account information. For example, a card may include a timestamp generator, the function(s) and/or data associated with a function(s) (e.g., information stored in a LUT including data determined using function(s)), an identifier and/or other private and/or public information. The identifier may be a user identification, an account identification, a card identification and/or the like.

The card may be provided to the user of the account associated with the card (e.g., as in 430). The user may use the card to initiate a transaction. For example, the user may initiate a transaction with a card reader using the card. The card may generate a timestamp, and generate dynamic data and/or select data from storage. For example, the card may determine a solution using the function(s), the timestamp, and/or other data to generate or determine a dynamic code.

An entity processing the transaction (e.g., an acquirer and/or issuer) may receive transactional data including the identifier, the dynamic code, one or more functions, the timestamp and/or other data (e.g., as in 435). The entity processing the transaction may determine that the transactional information includes dynamic data, and communicate some or all of the information to a dynamic data verification server. The dynamic data verification server may retrieve a function(s) or select a verification code (e.g., from local secure storage) using the identifier and the timestamp. If any function is retrieved, a solution or a range of solutions to the function(s) may be determined to obtain a verification code. The verification code may be compared to the dynamic code to determine a result based on a degree of similarity (e.g., a match to a solution or a match within a range of codes) between the verification and dynamic codes (e.g., as in 440). The result may indicate whether a dynamic number is valid and may be communicated, for example, to a card reader (e.g., as in 445).

According to example embodiments, verifying dynamic data may reduce unauthorized use of an account (e.g., unauthorized by a user), for example, without a requirement of bi-directional communication between a device (e.g., a powered card and/or mobile telephonic device) and a processing entity. Facility-based synchronization between a card and a verification facility may reduce power consumption at the card and/or mobile device. Information not available or accessible by a card may be used in the synchronization process. The verification facility may be a remote facility, and may not be a conventional transactional entity, such that conventional transactional entities need not upgrade existing equipment and/or perform fewer or smaller upgrades as compared to without the verification facility. Multiple, different issuers may utilize a single verification processor, resulting in an increased reduction in infrastructure modification.

Persons skilled in the art will appreciate that various elements of different example embodiments may be combined in various ways. Persons skilled in the art will also appreciate that the present invention is not limited to only the embodiments described. Instead, the present invention more generally involves dynamic information. Persons skilled in the art will also appreciate that the apparatus of the present invention may be implemented in other ways than those described herein. All such modifications are within the scope of the present invention, which is limited only by the claims that follow.

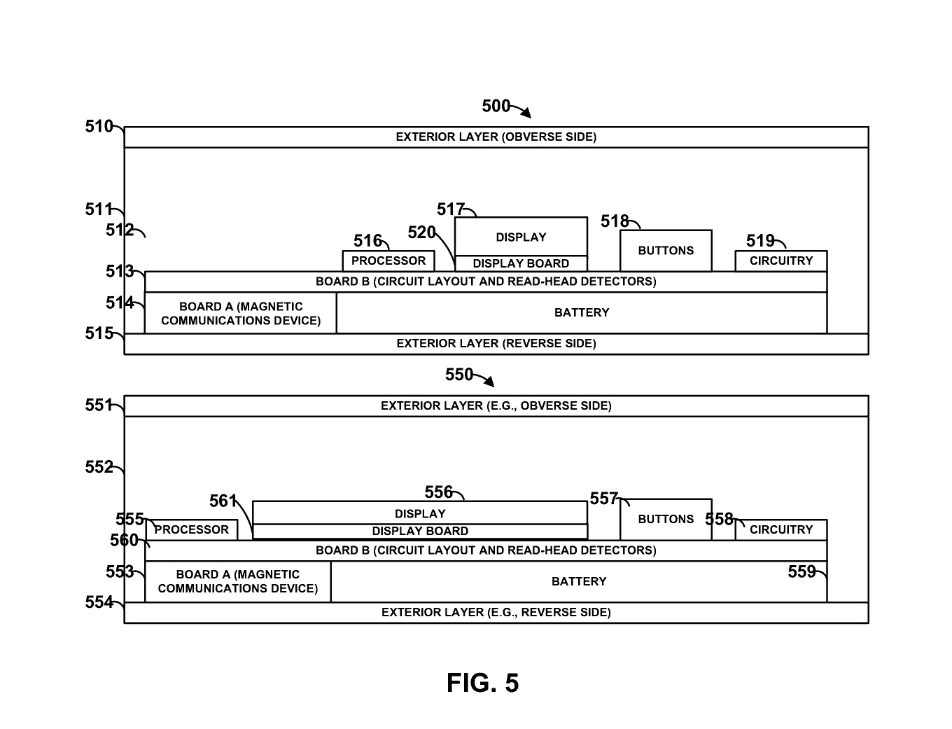

FIG. 5 shows cards 500 and 550 according to principles of the present invention. Card 500 may be, for example, between 25 and 40 thousandths of an inch thick (e.g., approximately between 30 and 33 thousandths of an inch thick). Card 500 may include, for example, layer 510. Layer 510 may be a polymer, for example, polyethelene terephthalate and/or the like. Similarly, layer 515 may be included as a polymer, for example, polyethelene terephthalate and/or the like. An electronics package may be fixed (e.g., glued) to layer 515 or 510, and laminated via injection molding (e.g., reaction injection molding) to form laminate 511. Laminate 512 may be formed from one or more polyurethane-based or silicon-based substances.

To fabricate a card that is approximately 30 to 33 thousandths of an inch thick, for example, layer 515 and 510 may be approximately 5 to 7 thousandths of an inch thick (e.g., 5 thousandths of an inch thick). An electronics package may be less than approximately 10 to 20 thousandths of an inch thick (e.g., less than approximately 16 thousandths of an inch thick). Accordingly, for example, an area of laminate 511 between an electronics package and a layer may be a thickness such that an electronics package, layers 510 and 515 are approximately 33 thousandths of an inch thick. For example, laminate 511 may be approximately 3 to 10 thousandths of an inch thick (e.g., approximately 7 thousandths of an inch thick).

The volume of the electronics package of a powered card may be, for example, less than approximately two tenths of a cubic square inch (e.g., approximately less than one tenth of a cubic square inch). Such an electronics package may include multiple flexible boards, a battery, dynamic magnetic stripe communications device, magnetic stripe communications device drive circuitry, and multiple light emitting diodes.

Persons skilled in the art will appreciate that a protective layer may be placed over layer 510 and 515. Such a layer may be between approximately 0.5 and 2 thousandths of an inch thick (e.g., approximately 1.5 thousandths of an inch thick). Accordingly, for example, the combined thickness of two protective layers may be approximately 3 thousandths of an inch, the combined thickness of two exterior layers may be approximately 10 thousands of an inch, the thickness of an electronics package may be approximately 16 thousandths of an inch, and the thickness of a laminate between an electronics package and an exterior layer may be approximately 4 thousands of an inch. Persons skilled in the art will also appreciate that an injection molding process of a substance may allow that substance to fill into the groove and gaps of an electronics package such that the laminate may reside, for example, between components of an electronics package.

Card 500 may include an electronics package that includes, for example, board 512, processor 516, display 517, buttons 518, additional circuitry 519, board 513, and battery 514. Board 512 may be, for example, a dynamic magnetic communications device. A permanent magnet may be, for example, provided as part of an assembled board 512 or fixed (e.g., flexibly fixed) to the top of board 512. Board 513 may include, for example, capacitive and/or inductive read-head detectors placed about board 512. Battery 514 may be any type of battery, such as, for example, a flexible lithium polymer battery. Circuitry 519 may include, for example, one or more driver circuits (e.g., for a magnetic communications device and display 517), RFIDs, IC chips, wireless radio transceivers, light sensors and light receivers (e.g., for sending and communicating data via optical information signals), sound sensors and sound receivers, or any other component or circuitry for card 500. Read-head detectors for detecting the read-head of a magnetic stripe reader may be provided, for example, on board 512 and/or 514 as capacitive proximity sensors (e.g., capacitive-sensing contact plates) and/or inductive conductor sensors.

Circuitry 519 may include, for example, a chip including a display drive circuit. The drive circuit may drive display 517, for example, display units (e.g., segments) of display 517. Processor 516 may control the drive circuit.

Components on a board may be connected, for example, via surface mount assembly techniques, wire-bonding assembly techniques, and/or flip chip assembly techniques.

Display 517 may be on display board 520. Display board 520, processor 516 and the display driver of circuitry 519 may be on different portions of board 513. Processor 516 may be connected to the driver circuit via board 513. Display 517 may be connected to the display driver of circuitry 519 via display board 520 and board 513. The number of connections between the display and display board 520, between display board 520 and board 513, and between board 513 and the display driver may be related to, among other factors, the number of display units (e.g., segments) of display 517.

The display used for display 517 may be limited to a particular size or a particular number of display units (e.g., segments), and/or a card manufacturing process may be more complicated for enhanced and/or large footprint displays. Due to the number of connections required between display board 520 and board 513, and between board 513 and the drive circuitry, a manufacturing process to include a enhanced and/or large display in card 500 may require additional and/or more expensive equipment, consume more material, require greater processing times, have decreased line yield and/or increased failure rates.

Card 550 may be provided and may include, for example, exterior layers 551 and 554, laminate 552, board 553, battery 559, processor 555, display 556, buttons 557, circuitry 558, board 560 and display board 561. Circuitry 558 may include, for example, drive circuitry for a dynamic magnetic stripe communications device, programming sensors (e.g., infrared sensors), and light emitting diodes.

Display 556 may be an enhanced display, an improved display, and/or a large footprint display. Drive circuitry for display 556 may be on and/or in display board 561. Display 556 may be connected to the drive circuitry directly and/or by fabricating the connections directly on display board 561, for example, using a printed circuit board fabrication technique. Display 556 may be connected to drive circuitry without connecting via board 560 (without connecting via a primary board). Processor 555 may be connected to the drive circuitry of display board 561 via display board 561 and/or board 560.

A number of required connections between display board 561 and board 560 may be reduced as compared to a card with a display driver on board 560 by a factor of about 5. For example, if 10-20 connections are required for a display driver on (or in) display board 561, 50-100 connections may be required if display driver is on board 560.

According to example embodiments, a large, improved and/or enhanced display may be included in card 550 using an existing manufacturing process, or with process that is less complicated than for a card with a display driver on a primary board. Card 550 may be more durable, with fewer potential points of failure. The amount of space (real estate) available within card 550 for routing additional components may be increased and/or a card design may be less complicated. Display 125 may be a 1 inch by 1 inch display, a 1 inch by 1.5 inch display, a 1 inch by 2 inch display, and/or the like.

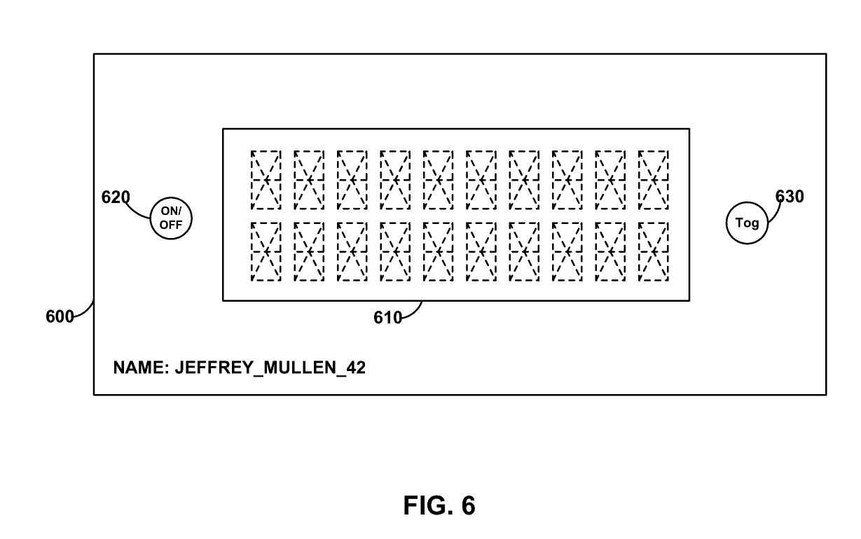

FIG. 6 shows device 600 according to principles of the current invention. Device 600 may be, for example, a multi-instrument device including display 610, on/off button 620 and/or toggle button 630. Device 600 may act as a surrogate for multiple different instruments, for example, a credit card, a debit card, a stored value card, a driver's license, a passport, an access card, a transportation card, a loyalty card, a rewards card, an incentive card, a coupon, a gift card, a game action card and/or any other instrument.

Device 600 may include multiple different communication interfaces compatible with multiple different types of devices (e.g., readers). For example, device 600 may include a dynamic magnetic stripe to communicate with a magnetic stripe reader, an exposed chip interface to communicate with a contact smartcard reader, an unexposed chip interface to communicate with a contactless smartcard reader, an EMV reader compatible interface, an RFID interface to communicate with an RFID reader, a NFC interface to communicate with an NFC reader, a Bluetooth interface to communicate with a Bluetooth device, a IC radio module to receive from or communicate with a radio device, a light receiver and/or transceiver to receive from or communicate with a light based device (e.g., a display screen), a capacitive touch interface to communicate with a touch interface (e.g, a touch screen) and/or the like.

Device 600 may communicate and/or receive information during, before or after a transaction (e.g., at any time) using any communication interface included with device 600. For example, device 600 may be swiped through a magnetic stripe card reader during a purchase transaction and may communicate magnetic stripe data using a dynamic magnetic communications device.

As another example, device 600 may include an IC radio module and may receive various types of information from a radio broadcaster (e.g., a pager system). The types of information may include new card data, an update to an expired card, an instruction to delete one or more cards, an instruction to deactivate device 600 (e.g., where device 600 is compromised), an instruction to add a new reward or feature, an instruction to notify a user of a new sale or bonus item, an instruction to display advertising information (e.g., from a card reader and/or a public venue broadcasting system), an instruction to update firmware, an instruction to activate an inactive product, an instruction to increase or decrease card spending limits and/or an instruction to activate or deactivate features under subscription model.

Display 610 may be an enhanced display, an improved display and/or a large footprint display. Display 610 may be, for example, a multi-segment, a multiline display, a dot matrix display and/or the like. Display 610 may be sized according to an ISO standard device 600, and may be, for example, 1 inch by 1 inch, 1 inch by 1.5 inches and/or 1 inch by 2 inches. According to some example embodiments, device 600 may not be sized according to ISO standards and a size of display 610 may be compatible with the non-standard size. Display 610 may be variously located with respect to edges of device 600. For example, device 600 may be centered, left justified, right justified, top justified, bottom justified and/or vertically justified.

According to some example embodiments, display 610 may be a multiline display including two or more lines of 5-20 characters per line, for example, 9 characters per line, 10 characters per line and/or 18 characters per line.

Toggle button 630 may toggle display 610 between different display screens. For example, a user may press power button 620 and a first display screen may be displayed. Device 600 may automatically switch to a second display screen, and thereafter periodically switch between the first and second display screens. A length of time device 600 displays the first display screen and a length of time device 600 displays the second display screen may be different or the same. For example, device 600 may display the second display screen for a longer period of time in a case where the second display screen includes information that is more difficult for a user to retain in short term memory, and vice versa. According to some example embodiments, device 600 may display three or more display screens and automatically switch between two or more of the display screens.

A display screen may be information simultaneously displayed by display 610. For example, display 610 may be a two line display with two 10-digit lines. A first display screen may include the name of a card type identifier (e.g., BankName/Debit), an expiration date, and a CVC (e.g., a CVV, CVV2, CVC, CVC2, CID and/or DCVC). The second display screen may display, for example, a 15 or 16 digit card number.

The card number may be displayed using both lines of the second display screen.

A user may press toggle button 630 and device 600 may display information associated with a different instrument. For example, a user may press toggle button 630 to display a first display screen associated with a different card. Display 610 may display the name (e.g., MerchantName/GiftCard) and other information related to the different card. Device 600 may automatically switch to a second display screen of the different card, for example, including a 15 or 16 digit card number.

Device 600 may periodically toggle between display screens, for example, while device 600 is on and/or for a period of time. Device 600 may turn off and/or cease to display information after an event. For example, device 600 may turn off, or turn display 610 off, after a transaction, after a communication is acknowledged and/or based on user input (or lack of input).

The user may press toggle button 630 a second time and device 600 may display a first display screen associated with a driver's license. The first display screen may display information related to the driver's license. For example, display 610 may display the name (e.g., State Name/Driver's License) driver's license number, license class, and expiration date when the first display screen is displayed. Device 600 may automatically toggle to a second display screen, for example, displaying physical characteristics of the user, such as height, weight, hair color and and eye color. Device 600 may automatically toggle to a third display screen, for example, displaying license requirements, for example, whether or not the user is required to wear corrective lenses. Device 600 may automatically toggle to a fourth display screen to display a validation code that may be used to authenticate the driver's license data (e.g., in lieu of a hologram).

A user may press toggle button 630 to switch between every instrument stored in device 600 and/or a subset of instruments stored in device 600. For example, a user may group instruments stored in device 600 via a graphical user interface on a mobile device (e.g., a mobile telephonic device) and may name the groups. For example, a user may group rewards cards group “Rewards,” access cards in group “Access,” and payment cards in group “Financial.” The mobile device may provide grouping instructions to card 360, for example, through a communication interface. A user may switch between groups of toggled instruments by, for example, pressing toggle button 630 for a period of time (e.g., 2-4 seconds) and/or a number of times in quick succession (e.g., 2-4 times). Device 600 may display grouping information in the instrument name (e.g., “BankName/Credit/Financial”). Once a group is selected, a user may toggle through the selected group by pressing toggle button 630 for less than 2 seconds.

According to example embodiments, a card may display more than one screen of card data for a particular card such that a user may access instrument data exceeding a number of segments displayable by display 610. Display 610 may display 2 times the number of symbols displayable by the display by toggling between two display screens, 3 times the number of symbols by toggling between three display screens, 4 times the number of symbols by toggling between four display screens, and so on. For example, a user in possession of device 600 including a two line, 16 segment display (i.e., 8 segments per line) may have access to 32 segments with two display screens, 48 segments with three display screen and 64 segments with three display screens.

A user may press toggle button 630 one or more times to select a particular instrument from among multiple instruments, and device 600 may communicate data to a reader or other device based on the currently displayed instrument. For example, device 600 may begin communicating data upon detecting a reader and/or upon detecting that a user has not switched between cards for a period of time (e.g., a static period of time and/or a multiple of the average time a user takes to switch between cards).

Device 600 may communicate data in a format expected by a type of reader. Device 600 may include reader detectors (not shown) to detect a type of reader and communicate transaction information associated with the selected card in the format expected by the type of reader. For example, device 600 may communicate data in a different format to each of a passport reader, a barcode scanner, a smart card reader, a magnetic stripe reader and/or the like.

Different formats or versions of data associated with the same underlying account may be stored on device 600, and/or device 600 may assemble messages from stored data based on the detected or user selected reader. For example, ISO compliant data may be stored in device 600 as different transaction messages for a particular card (e.g., in a LUT).

Device 600 may detect a particular type of reader and select a transaction message for communication based on the type of card reader and the card displayed by display 610. As another example, card 610 may include a processor and instruction sets for assembling messages based on the type of card reader. Device 600 may detect a particular type of card reader and assemble a transactional message for communication based on an instruction set associated with the type of card reader and underlying transactional information associated with a card displayed on display 610.

For example, device 600 may detect a smartcard reader and select a message associated with the selected card in a format compliant with ISO standards for smartcards. As another example, device 600 may detect a magnetic stripe reader, and use an algorithm to compose a message for the selected card in a format compliant with ISO standard for magnetic stripe cards. If the selected card is a dynamic card, device 600 may, for example, assemble the message using dynamic data in place of static data (e.g., use a DCVC in place of a CVC).

According to example embodiments, if device 600 detects a device requiring a token, the token may be generated or retrieved from memory, and communicated to the external device.

Device 600 may, for example, receive a selection of a type of reader from a user and communicate transactional information associated with the selected instrument in the format of the selected reader. For example, a user may toggle between sets of information for the same card. The name of the instrument may be displayed as, for example, ‘Name/CardType/ReaderType.’ A user may press toggle button 630 a number of times in rapid succession to switch between groups of instruments, press toggle button 630 for less than one second to toggle between cards, and press toggle button 630 for a number of seconds to toggle between card reader types associated with the card (e.g., 1-3 seconds), and press toggle button 630 and power button 620 simultaneously for a different function. If the user presses toggle button for a number of seconds, a different set of display screens for the same account but a different card reader type may be displayed. Alternatively, only the name of the instrument may change to reflect the currently selected type of reader.

According to some example embodiments, a user may toggle between card reader types when, for example, device 600 does not detect a particular card reader (e.g., a new kind of reader), the card reader is undetectable (e.g., receive-only wireless), and/or a card reader accepts multiple different formats of payment information and the user prefers a particular format. Similarly, a different entity, such as an issuer, may store a preference hierarchy for card reader types on device 600.

A default reader type may be set by a card manufacturer, an issuer and or a user, for example, based on a location in which the card will be used and/or a current location of the card. For example, an issuer may issue a card to a resident of the United states and set a default of communicating via a dynamic magnetic stripe communication device using the associated ISO compliant transaction message. As another example, device 600 may include a location device (e.g., a GPS or Wi-Fi receiver/transceiver) to determine a current location of card 360. For example, device 600 may include a GPS determining that device 600 is currently in Europe, and by default, device 600 may communicate data by contact and/or contactless smart card interfaces using the associated ISO compliant transaction message. As another example, device 600 may include a Wi-Fi transceiver, connect to a Wi-Fi hotspot and determine that device 600 is in Canada based on an IP address of the hotspot. Readers in Canada may accept magnetic stripe data or smart card data. A default hierarchy provided by an issuer may set device 600 to first attempt to communicate by a smartcard interface when a dual interface reader is detected.

According to example embodiments, a powered and/or dynamic card may store and display information for more than a single card, and may provide static and/or dynamic information for transactions. Displayed data may be used to complete transactions, for example, requiring manual entry of data and/or occurring at a location with limited access to financial transaction systems. Examples of such transactions may include, for example, a transaction with an internet merchant, a transaction with a merchant recording card information manually (e.g., by imprinter), a transaction with a retail merchant having a broken or disconnected reader, and/or the like.

Although device 600 is shown with two buttons, additional buttons may be provided. For example, a number of buttons may be provided to enter an unlocking code. Display 610 may switch to an unlocking display screen when, for example, a user begins to enter an unlocking code or when power button 620 is pressed. The unlocking code display screen may or may not display the symbols entered using the buttons, and may display messages associated with a successful or unsuccessful entry of an unlocking code. As another example, display 610 may perform various functions with respect to single accounts associated with different buttons or sets of toggled accounts associated with different buttons. According to some example embodiments, a button may be used to toggle display screens and cards. For example, a button may be pressed to switch through each display screen of a first card, and upon reaching the last display screen of the first card, the next button press may cause display 610 to display the first screen of the second card.

According to some example embodiments, device 600 may receive, store and communicate open network cards that may be communicated through more than one payment network. An open network card may be received by device 600 via any communication interface, for example, a Bluetooth interface. Device 600 may include printed network logos for each payment network, for example, four network logos. Device 600 may backlight a logo of the network associated with the currently selected card, and/or backlight each payment network associated with an open network card.

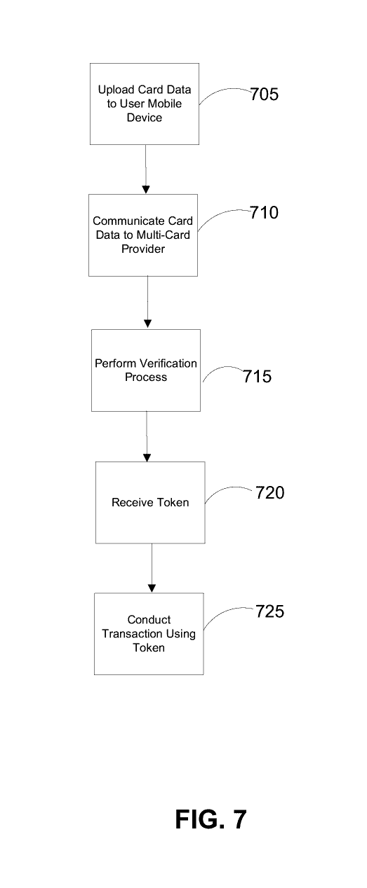

FIG. 7 shows a token transaction method performed in accordance with the principles of the present invention. Referring to FIG. 7, a user may initiate a tokenization process required to utilize a transaction card with a multi-card device (e.g., as in step 705). The process may be initiated by uploading card data associated with the transaction card to a user computing device (e.g., a mobile telephonic device, a PDA, a laptop and/or a desktop computer) and communicating the card data to a multi-card provider (e.g., a provider of a multi-card application and/or a provider of a multi-card device, such as a dynamic and/or powered card manufacturer and/or retailer).

For example, the transaction card may be a magnetic stripe card, such as credit or debit card. The user may upload the card data to the user's computing device by, for example, manually entering the card data into the computing device, obtaining the card data using a card reader connected to the computing device (e.g., a card reader provided by the multi-card provider), capturing one or more images of the card for OCR recognition (e.g., using a camera of the computing device) and/or verbally entering the card data using a voice recognition function of the computing device. Once the card data is uploaded, the user may communicate the card data to the multi-card provider by, for example, communicating the card data over an IP network to a processing server (e.g., as in step 710).

A verification process may be performed to determine if the user is associated with the card data and/or a financial institution is associated with the card data (e.g., as in step 715). For example, the user and/or the multi-card provider may connect with, for example, a payment network and/or a financial institution (e.g., a bank and/or issuer) associated with the card data. For example, the multi-card provider may connect via web services and/or a direct socket point-to-point connection, and the user may log-in using a log-in identity associated with the payment network, the financial institution and/or the multi-card provided by the multi-card provider. According to some example embodiments, the user may, additionally or alternatively, use the transaction card with a reader. For example, the user may swipe the transaction card at a point-of-sale device.

Upon completion of the verification process, the user may receive one or more tokens (e.g., as in step 720). For example, the payment network and/or the financial institution may communicate one or more tokens to the multi-card provider and/or the user mobile device. For example, the token may be directly usable by an application residing on the user's computing device, the multi-card provider may embed the token into an application and communicate the application to the user's computing device, the token and any required firmware/software may be communicated from the multi-card provider to the user's multi-card device, and/or the multi-card provider may provide a complete multi-card device (e.g., including the token) to the user (e.g., as in step 720). The user may conduct a transaction and the token may be communicated for authorization of the transaction (e.g., as in step 725).

According to some example embodiments, one or more tokens may be retrieved by a multi-card device or application during a transaction, or a simulated transaction. For example, one or more tokens may be downloaded to a multi-card device that is used at a card reader (e.g., a point-of-sale IC chip and/or magnetic stripe card reader). Accordingly, tokens may be changed at any time. For example, a payment network and/or financial institution may change a token periodically. Compromised tokens may be replaced. Card expirations may be transparent to a user.

According to example embodiments, a single token may be provided. According to other example embodiments multiple tokens may be provided. Different tokens may be provided for different types of transactions. Different tokens may be provided for different communication interface based transactions (e.g., EMV, magnetic stripe, etc.). For example, different tokens may be provided for secure connections and unsecured connections of a multi-card application (e.g., an application residing on a user's computing device). As another example, different tokens may be provided for wired and wireless connections of the user's mobile device and/or multi-card device. As yet another example, a different token may be provided for secure internet transactions, unsecure internet transactions, identity verified point-of-sale transactions (e.g., signature, photo ID, etc.) and/or identity unverified point-of-sale transactions. As still another example, different tokens may be provided for transactions via different card readers (e.g., a square reader v. a VeriFone reader) and/or transactions at different locations (e.g., domestic, international, country, state and/or city, for example, based on fraud data). As still yet another example, different tokens may be provided for one or more (e.g., some, groupings, or all) of dynamic magnetic stripe transactions, exposed chip transactions, unexposed chip transactions, EMV transactions, RFID transactions, NFC transactions, Bluetooth transactions, transactions using an IC radio module, light-based transactions (e.g., infrared), capacitive touch interface transactions, and/or any other communication interface based transaction.

According to example embodiments, the information downloaded to a multi-card device or multi-card application may include unique payment card data, for example, one or more unique card numbers, such that the unique data resides on the multi-card. Accordingly, if data is compromised during one type of transaction, the token may be determined invalid, and a user may continue to complete other types of transactions. For example, a unique card number may be used for each of contact IC transactions, contactless IC transactions, and dynamic magnetic stripe transactions. A token used for dynamic magnetic stripe transactions may be compromised (e.g., by skimming), a payment network and/or financial institution may invalidate the token. Future transactions using the invalidated token will be declined and future transactions using tokens assigned to contact or contactless IC transactions will continue to be accepted. Further, a payment network or financial institution may invalidate a token assigned to one type of transaction (e.g., magnetic stripe reader transactions) that unexpectedly appears in a different type of transaction (e.g., an online transaction), such that the magnet stripe reader transaction token may no longer be used.

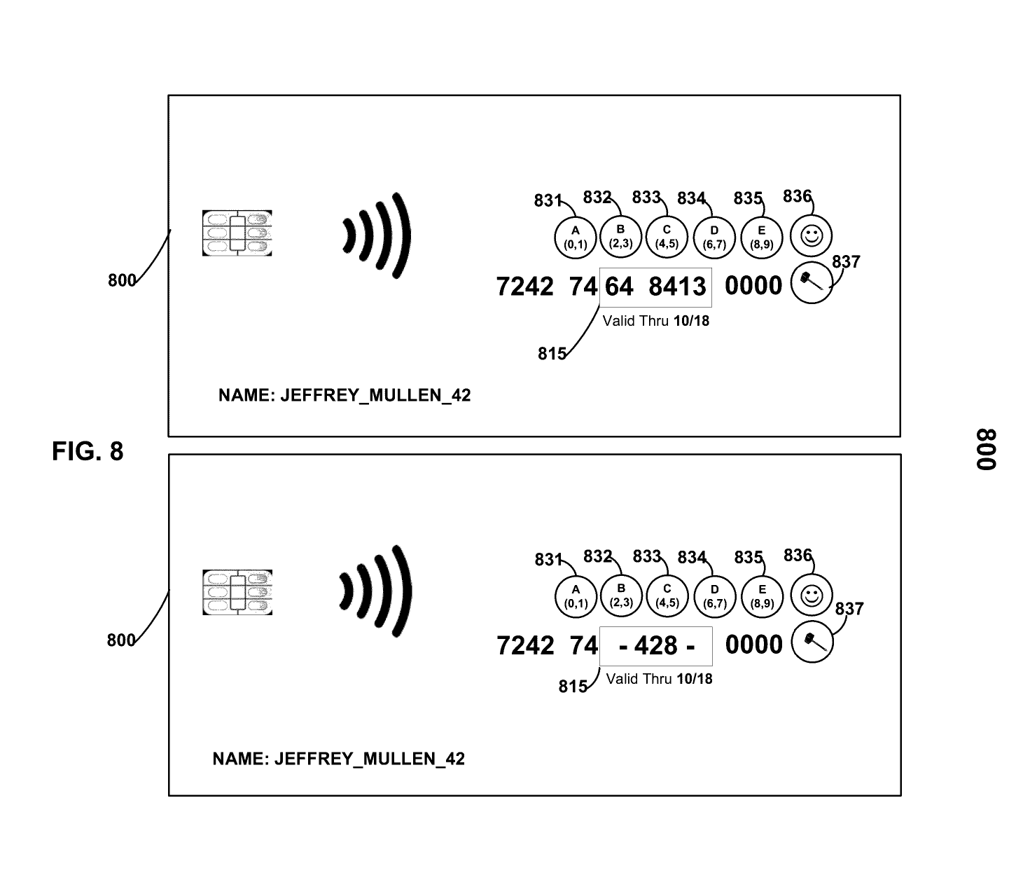

FIG. 8 shows card 800 according to the principles of the present invention. Reference numeral 810 may show card 800 during a first period of time and reference numeral 820 may show card 800 at a second period of time. Referring to FIG. 8, a portion of a dynamic card number may be displayed on display 815 during the first time period and a dynamic security code may be displayed on display 815 during the second time period. For example, a user may activate card 800, and display 815 may automatically switch between display of the portion of the dynamic card number and the display of the dynamic security code, for example, periodically. As another example, a user may toggle between displaying the portion of the dynamic card number and displaying the dynamic security code using one of buttons 131-137.

What is claimed is:

1. A device comprising:
a battery; and
a circuit operable to generate dynamic verification data.

2. The device of claim 1, wherein the dynamic verification data is a dynamic verification code.

3. The device of claim 1, wherein the dynamic verification data is a dynamic verification value.

4. The device of claim 1, further comprising a transmitter operable to transmit the dynamic verification data.

5. The device of claim 4, wherein the transmitter is operable to wirelessly transmit the dynamic verification data.

6. The device of claim 4, wherein the transmitter is an IC chip.

7. The device of claim 4, wherein the transmitter is a RFID.

8. The device of claim 4, wherein the transmitter is a Bluetooth Interface.

9. The device of claim 4, wherein the transmitter is a dynamic magnetic stripe.

10. The device of claim 9, wherein the dynamic magnetic stripe is operable to emulate magnetic stripe data.

11. The device of claim 9, wherein the dynamic magnetic stripe is operable to encode magnetic stripe data.

12. The device of claim 1, further comprising a display operable to display the dynamic verification data.

13. The device of claim 1, further comprising a display operable to display the dynamic verification data wherein the circuit is operable to generate a second dynamic verification data.

14. The device of claim 1, further comprising:
a display operable to display the dynamic verification data;
a second circuit is operable to generate a second dynamic verification data; and
a transmitter operable to transmit the second dynamic verification data.

15. The device of claim 1, further comprising a time stamp generator operable to generate a time stamp, wherein the circuit is further operable to utilize the time stamp.

16. The device of claim 1, further comprising a time stamp receiver operable to receive a time stamp, wherein the circuit is further operable to utilize the time stamp.

17. A device comprising:
a communication port operable to receive identification data and dynamic verification data; and
a processor operable to verify the identification data based on the dynamic verification data.

18. The device of claim 17, wherein the dynamic verification data is a dynamic verification code.

19. The device of claim 17, wherein the dynamic verification data is a dynamic verification value.

20. The device of claim 17, wherein the communication port is further operable to receive communication flow information.
